(19) United States
(12) Patent Application Publication
(10) Pub. No.: US 2020/0211721 A1
(43) Pub. Date: Jul. 2, 2020

(54) METHOD AND APPARATUS FOR DETERMINING AN IDENTITY OF AN UNKNOWN INTERNET-OF-THINGS (IoT) DEVICE IN A COMMUNICATION NETWORK

(71) Applicants: Singapore University of Technology and Design, Singapore (SG); B. G. Negev Technologies and Applications Ltd., at Ben-Gurion University, Beer Sheva (IL)

(72) Inventors: Martin OCHOA, Singapore (SG); Nils Ole TIPPENHAUER, Singapore (SG); Juan GUARNIZO, Singapore (SG); Yuval ELOVICI, Beer-Sheva (IL); Asaf SHABTAI, Beer-Sheva (IL); Michael BOHADANA, Beer-Sheva (IL); Yair MEIDAN, Beer-Sheva (IL)

(21) Appl. No.: 16/489,691

(22) PCT Filed: Feb. 27, 2018
(86) PCT No.: PCT/SG2018/050089

§ 371 Date: Aug. 28, 2019

(30) Foreign Application Priority Data
Mar. 2, 2017 (SG) 10201701692Y

(51) Int. Cl. G16Y 20/20; G16Y 30/00; G16Y 10/75; G06N 20/00; G06K 9/62

(52) U.S. Cl. CPC G16Y 20/20; G16Y 30/00; G06K 9/6259; G06N 20/00; G16Y 10/75

(57) ABSTRACT

A method and apparatus for determining an identity of an unknown Internet-of-Things (IoT) device in a communication network is disclosed. The method includes the steps of receiving network traffic generated by the unknown IoT device, extracting device network behavior from the generated network traffic, and determining the identity of the unknown IoT device from a list of known IoT devices by applying a selected machine learning based classifier from a set of machine learning based classifiers to analyze the device network behavior. Each machine learning based classifier of the set is trained by a dataset including a plurality of features representing network behavior of a respective known IoT device from the list and the known IoT device's identity. The plurality of features is associated with the corresponding device network behavior of the generated network traffic.

### TECHNICAL FIELD

The present disclosure relates to identifying devices connected in a network, and more particularly, to methods for determining an identity of an unknown Internet-of-Things (IoT) device in a communication network.

### BACKGROUND

Internet-of-Things (IoT) is a term used to describe various aspects related to the extension of the

Internet into the physical realm, by means of widespread deployment of spatially distributed devices with embedded identification, sensing, and/or actuation capabilities. IoT is enabled by the growth of the Internet and network-enabled objects. Until relatively recently, the Internet was primarily used to connect users to each other, and also to available information. With the growth of these network-enabled objects, the Internet is increasingly used to connect people to these objects and also to connect objects to each other. Some real-world examples of such objects are refrigerators, air-conditioners, audio systems, security cameras, and many other everyday devices embedded with electronics that enable these devices to be connected to a communication network.

IoT has been experiencing rapid growth in recent years and is expected to continue to proliferate, becoming an integral part of everyday communications. Among the challenges that IoT poses to organizations are security issues stemming from the proliferation of such devices and the ever increasing number of IoT-enabled organizational assets. In some cases, due to the diversity and the inherent mobility of a large portion of these IoT devices, organizations may find it difficult to maintain an accurate record of the IoT devices connected to their networks at a given time. It would therefore be useful for tracking IoT devices connected to a network if unknown IoT devices that are connected to the network can be accurately identified.

To determine the identity of an unknown IoT device connected to a network, one method proposed looking at Media Access Control (MAC) addresses of devices that are connected to the network. The MAC address is uniquely assigned to a device when it is manufactured. The prefixes of MAC addresses can be used to identify the manufacturer of a particular device. However, no standard exists to identify brands or types of devices. Although, it is possible that manufacturers have their own ad hoc strategy to identify models that are produced by them, this must be reversed engineered for each manufacturer. Furthermore, the strategies might not be generalized to other manufacturers or newer models.

Thus, it is desirable to provide a method of determining an identity of an unknown IoT device in a communication network which addresses the problems of existing prior art and/or to provide the public with a useful choice.

### SUMMARY

Various aspects of the present disclosure are described here. It is intended that a general overview of the present disclosure is provided and this, by no means, delineate the scope of the invention.

According to a first aspect, there is provided a method of determining an identity of an unknown Internet-of-Things (IoT) device in a communication network. The method includes receiving network traffic generated by the unknown IoT device, extracting device network behavior from the generated network traffic, and determining the identity of the unknown IoT device from a list of known IoT devices by applying a selected machine learning based classifier from a set of machine learning based classifiers to analyze the device network behavior. Each machine learning based classifier of the set is trained by a dataset including a plurality of features representing network behavior of a respective known IoT device from the list and the known IoT device's identity. The plurality of features is associated with the corresponding device network behavior of the generated network traffic.

The network traffic may include a number of communication sessions having respective unlabeled feature vectors representing the device network behavior of the unknown IoT device. Each machine learning based classifier of the set may include a single session classifier associated with a respective known IoT device in the list. The single session classifier outputs a probability. Each machine learning based classifier of the set may include a classification threshold for comparing with the probability to determine if the session being analyzed is generated by a particular device in the known IoT device list. Each machine learning based classifier of the set may include a session sequence size which defines the number of communication sessions to analyze.

Analyzing the device network behaviour may include (i) analyzing the unlabeled feature vector of one of the communication sessions using the single session classifier of the selected machine learning based classifier to output the probability, (ii) comparing the probability with the classification threshold, and (iii) if the probability is higher than the classification threshold, (iv) classifying the communication session as being generated by a particular IoT device from the known IoT device list associated with the single session classifier, and (v) determining the identity of the unknown IoT device from the classification.

The method may further include selecting a next machine learning based classifier in the set if the probability is not higher than the classification threshold, using the single session classifier of the next selected machine learning based classifier to analyze the unlabeled feature vector and repeating steps (ii) to (v).

Alternatively, analyzing the device network behaviour may include (i) analyzing unlabeled feature vectors of consecutive communication sessions using the single session classifier of the selected machine learning based classifier to output corresponding probabilities, (ii) comparing each of the probabilities with the respective classification thresholds, (iii) if any of the probabilities are higher than the respective classification thresholds, (iv) classifying those communication sessions as being generated by a particular device from the known IoT device list associated with the single session classifier, and (v) determining the identity of the unknown IoT device based on the classification.

The method may further include selecting a next machine learning based classifier in the set if a majority of the probabilities is not higher than the respective classification thresholds, selecting a next machine learning based classifier in the set and using the single session classifier of the next selected machine learning based classifier to analyze the unlabeled feature vectors and repeating steps (ii) to (v).

The method may further include selecting the machine learning based classifier from the set in sequence starting from the machine learning based classifier having the lowest session sequence size to the highest session sequence size for analyzing the unlabeled feature vectors of the consecutive communication sessions.

The identity of each of the known IoT devices may include the device's make and model.

According to a second aspect, there is provided a method of creating a training dataset for a machine learning based classifier to be used for determining an identity of an unknown device in a communication network. The method includes generating network traffic from a plurality of IoT devices with known identities, extracting a plurality of features from the network traffic which are relevant to represent network behaviour of each one of the plurality of IoT devices, associating the extracted plurality of features with the corresponding identity of each one of the plurality of IoT devices, and creating the training dataset based on the association.

The method may further include converting the network traffic into communication sessions and extracting the plurality of features from each communication session.

The plurality of features may be extracted from network, transport and application layers of the network.

According to a third aspect, there is provided an apparatus for determining an identity of an unknown Internet-of-Things (IoT) device in a communication network. The apparatus is arranged to receive network traffic generated by the unknown IoT device. The apparatus includes a network feature extractor arranged to extract device network behaviour from the generated network traffic. The apparatus also includes a processor arranged to determine the identity of the unknown IoT device from a list of known IoT devices by applying a selected machine learning based classifier from a set of machine learning based classifiers to analyze the device network behaviour. Each machine learning based classifier of the set is trained by a dataset including a plurality of features representing network behaviour of a respective known IoT device from the list and the known IoT device's identity. The plurality of features is associated with the corresponding device network behaviour of the generated network traffic.

The apparatus may form part of a communication network which also includes a plurality of IoT devices which forms a fourth aspect.

### BRIEF DESCRIPTION OF THE FIGURES

An exemplary embodiment will now be described with reference to the accompanying drawings in which:

FIG. 1 is a schematic diagram of an exemplary communication network comprising a number of network enabled devices and a computer system for implementing a method of determining an identity of an unknown device based on a set of classifiers according to a preferred embodiment;

FIG. 2 is a flow diagram showing an exemplary method of forming a training dataset to train the set of classifiers used in the method to identify an unknown device as shown in FIG. 1;

FIG. 3 is a block diagram showing partitioning of the training dataset of FIG. 2;

FIG. 4 is a flow diagram showing an exemplary method of inducing a device identification model from the partitioned dataset of FIG. 3;

FIG. 5 is a flow diagram of an exemplary device identification process to determine the identity of an unknown device given a stream of unlabeled feature vectors using the device identification model of FIG. 4;

FIG. 6 is a flow diagram of an alternative device identification process which makes use of the device identification process of FIG. 5.

FIG. 7 is a flow diagram showing an exemplary method of determining the identity of an unknown IoT device after the non-IoT devices have been identified according to the alternative device identification process of FIG. 6.

### DETAILED DESCRIPTION

One or more embodiments of the present disclosure will now be described with reference to the figures. The use of the term “an embodiment” in various parts of the specification does not necessarily refer to the same embodiment. Features described in one embodiment may not be present in other embodiments, nor should they be understood as being precluded from other embodiments merely from the absence of the features from those embodiments. Various features described may be present in some embodiments and not in others.

Additionally, figures are there to aid in the description of the particular embodiments. The following description contains specific examples for illustration. The person skilled in the art would appreciate that variations and alterations to the specific examples are possible and within the scope of the present disclosure. The figures and the following description should not take away from the generality of the preceding summary.

### OVERVIEW

In the present embodiment, machine learning techniques are applied to network traffic data obtained from a list of known IoT devices in order to train a set of classifiers to accurately determine, from the list of known IoT devices, the identity of unknown IoT devices that are connected to a network by analyzing the network behaviour of the unknown IoT devices.

Additionally, since non-IoT devices are often also connected to the network, the present disclosure also distinguishes non-IoT devices from IoT devices by determining the identity of the non-IoT devices connected to the network. Therefore, in a broader aspect, the described embodiment is able to determine the identity of network-enabled devices connected to the network.

Network-enabled devices may include IoT and non-IoT devices. As opposed to non-IoT devices such as PCs, laptops, tablets and smartphones, IoT devices are typically resource-constrained task-oriented previously-unconnected appliances, fortified with various sensors and actuators. These IoT devices are designed to facilitate the automation and efficiency of numerous daily processes in virtually every aspect of modern life, such as home automation, manufacturing, healthcare, transit, and so forth. For instance, smart sockets are an example of IoT devices, as they have very limited computing power (in terms of CPU, memory, etc.), they support a specific predefined task (i.e., enable remote connection/disconnection of power, monitor power consumption) and they facilitate the automation of power saving.

In a preferred embodiment, there is provided a method of determining the identity of an unknown network-enabled device from a list of known network-enabled devices by applying a selected machine learning based classifier from a set of machine learning based classifiers to analyze the device network behaviour. Each machine learning based classifier of the set is trained by a dataset which includes a plurality of features representing network behaviour of a respective known network-enabled device from the list and the known device's identity. The plurality of features is associated with the corresponding device network behaviour of the generated network traffic.

To elaborate further, the description of the preferred embodiment is divided into two parts—the first part discusses how a set of classifiers can be trained using machine learning techniques to determine the identity of network-enabled devices from a list of known network-enabled devices, and the second part discusses how the trained machine learning based classifier determines the identity of unknown network-enabled devices communicating in a network.

### Data Acquisition

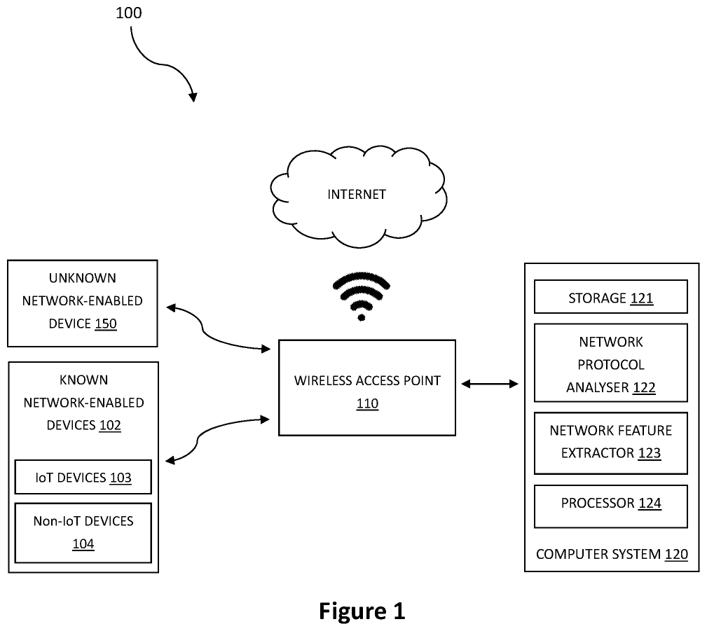

To train the set of classifiers, a training data set is first created from network traffic data of known network-enabled devices. The network traffic data is collected as such. FIG. 1 illustrates an exemplary communication network 100 with network-enabled devices 102 connected to and communicating over the internet via a wireless access point 110. A computer system 120 is connected to the wireless access point 110 to receive input from the wireless access point 110. When the devices 102 communicate over the internet via the wireless access point 110, network traffic is generated. The network traffic generated by each device 102 is picked up and recorded by the computer system 120 using an application called Wireshark which is a network protocol analyzer 122. The recorded packets of network traffic (TCP packets) are stored in storage 121 in the form of *.pcap files.

As mentioned, the network-enabled devices 102 may be IoT devices 103 or non-IoT devices 104. Table 1 provides an exemplary list of network-enabled devices 102 including their “make and model” and the number of TCP sessions collected for each device. The devices are indicative of devices that are commonly connected to a system's wireless network.

TABLE 1
Devices included in the dataset

| Specific | Device | | Number of |
|---|---|---|---|
| Device Type | Type | Make and Model | TCP Sessions |
| Baby Monitor | IoT | Beseye Baby Monitor | 2,072 |
| | | Pro Security System | |
| Motion Sensor | IoT | Wemo F7C028uk | 254 |
| Printer | IoT | HP OfficeJet Pro 6830 | 70 |
| Refrigerator | IoT | Samsung RF30HSMRTSL | 7,008 |
| Security | IoT | Withings WBP02/ | 980 |
| Camera | | WT9510 | |
| Socket | IoT | Efergy Ego | 342 |
| Thermostat | IoT | Nest Learning Thermostat 3 | 6,353 |
| TV | IoT | Samsung | 4,854 |
| | | UA55J5500AKXXS | |
| Smartwatch. | IoT | LG Urban | 687 |
| PC | Non-IoT | Deli Optiplex 9020 | 3,138 |
| Laptop | Non-IoT | Lenovo X200 | 4,907 |
| Smartphone | Non-IoT | LG G2 | 2,178 |
| Smartphone | Non-IoT | Galaxy S4 | 643 |

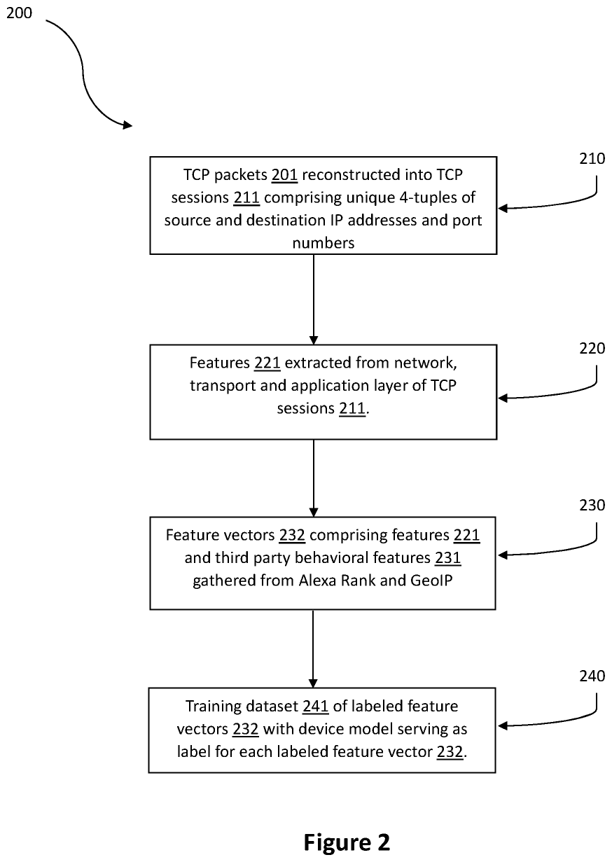

FIG. 2 is a flow diagram showing an exemplary method 200 of forming a training dataset according to an embodiment of the present disclosure. The method 200 is executed by a network feature extractor tool 123 of the computer system 120 shown in FIG. 1. The method 200 uses the *.pcap files stored in storage 121 of computer system 120.

At step 210, the network feature extractor tool 123 reconstructs *.pcap files containing TCP packets 201 to TCP sessions 211. Each TCP packet 201 is converted to a TCP session 211. Each TCP session 211 comprises unique 4-tuples consisting of source and destination IP addresses and port numbers, from the point of requesting a connection (SYN flag) to the end of the requested connection (FIN flag).

At step 220, features 221 are extracted from each TCP session 211. Features 221 represent unique properties of the TCP session 211 which defines the behaviour of the TCP session 211 in the network traffic. In the present embodiment, the data is extracted from the network, transport, and application layers of each TCP session 211.

In some embodiments, the features 221 extracted from the TCP may include destination port, packet sizes, number of packets with PUSH bit set, and average duration of a handshake.

The method 200 also uses third party information gathered from publicly available external databases. In the present embodiment, third party information from Alexa Rank and Geo IP are used. At step 230, behavioral features 231 from across different protocols and network layers of the third party information are added to respective features 221 extracted from each TCP session 211. Each TCP session 211 is characterized by a feature vector 232 comprising of features from both the TCP session 211 and corresponding third party information gathered from Alexa Rank and GeoIP.

It has been found that some features are regarded to be more valuable for modeling of the device behaviour. The following table illustrates the top 40 features which are regarded as being more valuable.

Feature

| | |
|---|---|
| 1 | ssl_count_client_key_exchange_algs |
| 2 | ttl_B_min |
| 3 | ds_field_B |
| 4 | packets_A_B_ratio |
| 5 | packet_size_firstQ |
| 6 | packet_inter_arrivel_B_firstQ |
| 7 | bytes_A_B_ratio |
| 8 | packet_inter_arrivel_A_median |
| 9 | packet_size_A_sum |
| 10 | packet_inter_arrivel_max |
| 11 | ttl_B_firstQ |
| 12 | http_dom_host_alexaRank |
| 13 | duration |
| 14 | B_port |
| 15 | ttl_stdev |
| 16 | packet_size_A_stdev |
| 17 | packet_size_B_sum |
| 18 | ssl_count_certificates |
| 19 | bytes |
| 20 | ttl_min |
| 21 | ttl_B_entropy |
| 22 | ssl_count_client_mac_algs |
| 23 | ssl_req_bytes_min |
| 24 | packet_size_A_thirdQ |
| 25 | ssl_handshake_duration_avg |
| 26 | reset_A |
| 27 | bytes_A |
| 28 | packet_size_avg |
| 29 | ttl_entropy |
| 30 | ssl_ratio_client_elliptic_curves |
| 31 | ssl_resp_bytes_max |
| 32 | ttl_B_var |
| 33 | ttl_B_median |
| 34 | ssl_count_client_ciphersuites |
| 35 | ttl_A_firstQ |
| 36 | packet_inter_arrivel_entropy |
| 37 | ack_B |
| 38 | push_B |
| 39 | push_A |
| 40 | ssl_dom_server_name_alexaRank |

At step 240 of FIG. 2, each feature vector 232 is labeled with the model of the respective devices 102 (hereinafter referred to as labeled feature vector) which originated the TCP session 211. The training dataset 241 is created by compiling the labeled feature vectors 232 into a single dataset.

Each device 102 is therefore represented by a set of labeled feature vectors 232 in the training dataset 241. The number of labeled feature vectors 232 representing each device 102 depends on the number of TCP sessions 211 recorded for the device 102.

### Inducing Device Identification Model

The device identification model is a set of machine learning based classifiers. The proposed method of FIG. 1 for determining the identity of an unknown (network-enabled) device 150 is a multi-stage process in which the set of machine learning based classifiers are applied to a stream of sessions that originate from the unknown device 150 that is connected to the network. The goal of the classifiers is to determine the identity of the unknown device 150 based on the captured network traffic that originated from the unknown device 150. For example, the device can be non-IoT (e.g., a PC or a smartphone), and the device can also be a specific IoT device. To train the classifiers, a supervised learning approach that utilizes the training dataset 241 is used for training the classifiers. The training dataset 241 includes features extracted from the traffic of all known network-enabled devices (i.e. devices that are connected to the internal network) and is created using the method described in FIG. 2.

The following notations are used in the embodiments of the present disclosure.
D: Set {d₁, . . . , dₙ,} of known network-enabled devices 102.
DSₛ: Dataset for inducing single-session (binary) classifiers, sorted in chronological order. The dataset includes labeled feature vectors representing sessions of devices in D.
Cᵢ: Single-session (binary) classifier for dᵢ, induced from DSₛ. This classifier classifies a given session as dᵢ or “other”. trᵢ*: Optimal classification threshold for Cᵢ.
DSₘ: Dataset for inducing multi-session based classifiers, sorted in chronological order. The dataset includes labeled feature vectors representing sessions of devices in D.
DSⁱₘ: Subset of sessions in DSₘ, originating from device dᵢ.
DSⁱₘ[a]: The a^{th} session, originating from dᵢ in DSⁱₘ.
   |DSⁱₘ|: The number of sessions in DSⁱₘ.
pᵢ^{s}: Posterior probability of a session s to originate from dᵢ; derived by applying Cᵢ to session s.
sᵢ*: The optimal (minimal) size of a sequence of sessions for which Cᵢ (the single session classifier of device dᵢ) classifies correctly most of the sessions (majority vote) in any sequence of sessions of size sᵢ* in DSₘ.
S^{d}: Sequence of sessions originating from device d.
C: Set {(C₁, tr₁*, s₁*), . . . , (Cₙ, trₙ*, sₙ*)} of single-session classifiers for devices in D with optimal thresholds trᵢ* and sequence sizes sᵢ*.
DSₜₑₛₜ: Dataset used for evaluating the proposed method (sorted in chronological order).
DSⁱₜₑₛₜ: Subset of DSₜₑₛₜ, originating from device dᵢ.
DSⁱₜₑₛₜ[a]: The a^{th} session (originating from dᵢ) in DSⁱₜₑₛₜ.

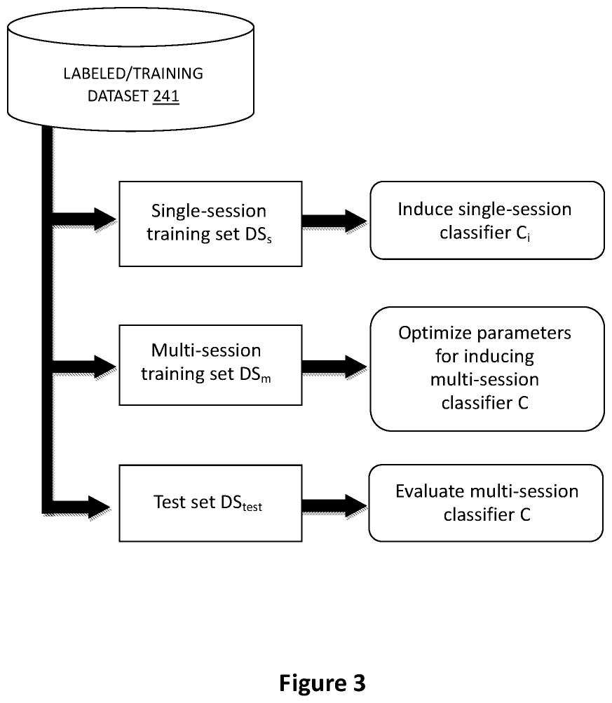

FIG. 3 is a block diagram showing an exemplary method 300 of partitioning of the labeled/training dataset 241 into three mutually exclusive sets for use in training and evaluating the set of machine-learning based classifiers. The labeled/training dataset 241 is divided chronologically into three mutually exclusive sets—a single-session training set DSₛ, a multi-session training set DSₘ, and a test set DSₜₑₛₜ. The single-session training set DSₛ is used to induce a single-session classifier Cᵢ and the multi-session training set DSₘ is used to optimize the parameters for inducing the multi-session classifier. The multi-session classifier is a set of single session classifiers Cᵢ with optimal thresholds trᵢ* and sequence sizes sᵢ*. The test set DSₜₑₛₜ is then used to evaluate the performance of the multi-session classifier.

In some embodiments, the test set DSₜₑₛₜ may be omitted and a labeled/training dataset 241 may be divided chronologically into two mutually exclusive sets consisting of a single-session training set DSₛ and a multi-session training set DSₘ. In other words, there will not be a final stage for evaluating the performance of the multi-session classifier.

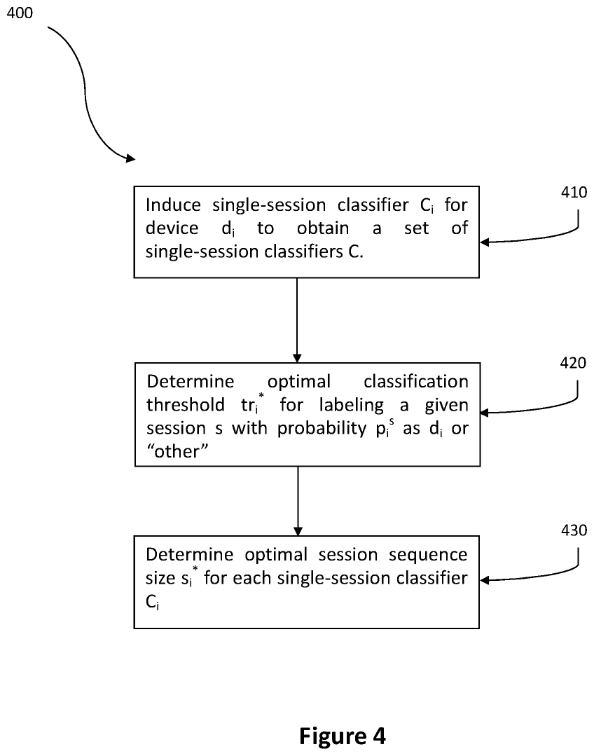

FIG. 4 is a flow diagram showing an exemplary method of inducing the device identification model from the partitioned dataset (i.e. single-session dataset DSₛ and multi-session dataset DSₘ) derived in FIG. 3.

At step 410, a single-session classifier Cᵢ is induced for each device dᵢ in the set of known devices D. D represents the set of known devices to be identified based on their network traffic. A set of single-session classifier C is obtained using the single-session training set DSₛ. To train Cᵢ for device dᵢ, DSₛ is transformed into a binary dataset such that all labeled feature vectors of sessions that belong to dᵢ are labeled as dᵢ, and labeled feature vectors of sessions that do not belong to dᵢ is labeled as “other”. Thus, given a feature vector (hereinafter referred to as unlabeled feature vector) extracted from a session that emanated from an unknown device, each single session classifier Cᵢ is applied to the unlabeled feature vector to obtain a vector of posterior probabilities (p₁^{s}, . . . , pₙ^{s}).

At step 420, the optimal classification threshold (cut-off value) trᵢ* for labeling a given session s with probability pᵢ^{s} as dᵢ or “other” is determined. The multi-session dataset DSₘ is used to evaluate the performance of the set of single session classifiers C, and for setting the optimal threshold values trᵢ*. Each optimal threshold trᵢ* was selected such that the accuracy of each single-session classifier Cᵢ is optimized for identifying device dᵢ.

At step 430, the optimal session sequence size sᵢ* for each single-session classifier Cᵢ is determined. The optimal session sequence size sᵢ* is obtained as such. First, for each device dᵢ represented in the multi-session training set DSₘ, the set of single-session classifiers C is applied to all labeled feature vectors to obtain the classification results. Then, the classification results of each optimized classifier is analyzed using the optimal classification threshold trᵢ* and multi-session dataset DSₘ. The optimal session sequence size sᵢ* is then the minimal number of consecutive session classifications whereby a majority vote will provide zero false positives and zero false negatives on the entire DSₘ.

Table 2 is an exemplary performance (i.e. False Negative Rate and False Positive Rate) of the single-session classifiers in determining identity of IoT devices after being optimized with trᵢ* and their optimal sᵢ*.

TABLE 2
Single-session classifier performance

| IoT Device | tr* | Method | FNR | FPR | s* |
|---|---|---|---|---|---|
| Printer | 0.35 | GBM | 0.3 | 0 | 11 |
| Security Camera | 0.5 | Random Forest | 0 | 0 | 1 |
| Refrigerator | 0.2 | XG Boost | 0.001 | 0.001 | 3 |
| Motion Sensor | 0.2 | XGBoost | 0.012 | 0 | 3 |
| Baby Monitor | 0.3 | XGBoost | 0.006 | 0 | 9 |
| Thermostat | 0.2 | Random Forest | 0.011 | 0.004 | 45 |
| TV | 0.1 | GBM | 0.026 | 0.001 | 23 |
| Smartwatch | 0.8 | XG Boost | 0.184 | 0 | 77 |
| Socket | 0.25 | Random Forest | 0 | 0 | 1 |

From Table 2, it is shown that some devices (e.g. security camera, socket, refrigerator) require lower optimal session sequence size sᵢ* for an accurate identification. From a macro point of view, the network behaviour of different network-enabled devices 102 varies according to the device. Some devices (e.g. security cameras) generate network traffic that is more ‘recognizable’ than the network traffic generated by other devices (e.g. thermostat). Since the network traffic is captured in the feature vectors of each device as described in FIG. 2, this in turn affects the number of sessions that needs to be classified to accurately identify the device. In general, the lower the optimal session sequence size sᵢ* is for a device dᵢ the smaller the number of consecutive sessions needs to be classified in order to accurately determine whether the sessions that originated from an unknown IP were generated by dᵢ or not. It is therefore advantageous to determine the optimal session sequence size sᵢ* so that the program does not classify more sessions than is needed to determine the identity of an unknown device thereby resulting in a more efficient system.

Algorithm 1 illustrates how the program calculates sᵢ* for each device dᵢ.

Algorithm 1: Calculating sᵢ*

| | |
|---|---|
| 1: | procedure FINDSISTAR(D, DSₘ, Cᵢ) |

| | |
|---|---|
| 2: | sᵢ* ← 1 |
| 3: | for dⱼ in D do |

| | |
|---|---|
| 4: | DSₘ^{j} ← subset of DSₘ with origin dⱼ |
| 5: | a ← 1 |
| 6: | s ← 1 |
| 7: | while a + s − 1 <= \|DSₘ^{j}\| do |

| | |
|---|---|
| 8: | n ← 0 |
| 9: | for sess in {DSₘ^{j}[a], . . . , DSₘ^{j} [a + s − 1]} do |

| | |
|---|---|
| 10: | pᵢ^{s} ← CLASSIFY(Cᵢ, sess) |
| 11: | if pᵢ^{s} > trᵢ* then |

| | |
|---|---|
| 12: | n ← n + 1 |

| | |
|---|---|
| 13: | if i = j and n > s/2 then |

| | |
|---|---|
| 14: | a ← a + 1 |

| | |
|---|---|
| 15: | else |

| | |
|---|---|
| 16: | a ← 1 |
| 17: | s ← s + 2 |

| | |
|---|---|
| 18: | if sᵢ* < s then |

| | |
|---|---|
| 19: | sᵢ* ← s |

| | |
|---|---|
| 20: | return Sᵢ* |

The multi-session classifier therefore comprises single-session classifiers Cᵢ, and the corresponding optimal threshold values trᵢ* and optimal session sequence size sᵢ*. For every device dᵢ there is a classifier Cᵢ with an optimal classification threshold trᵢ, and if a majority voting on its sᵢ* consecutive classifications is performed, the result of the majority voting determines whether sessions that emanated from a given IP were generated by dᵢ with 100% accuracy.

Device Identification Using the Trained Classifier

Given a stream of unlabeled feature vectors that emanated from an IP and generated by an unknown network-enabled device 150 in the communication network 100 of FIG. 1, an exemplary process 500 for determining the identity of the unknown network-enabled device 150 will now be described according to an embodiment of the present disclosure.

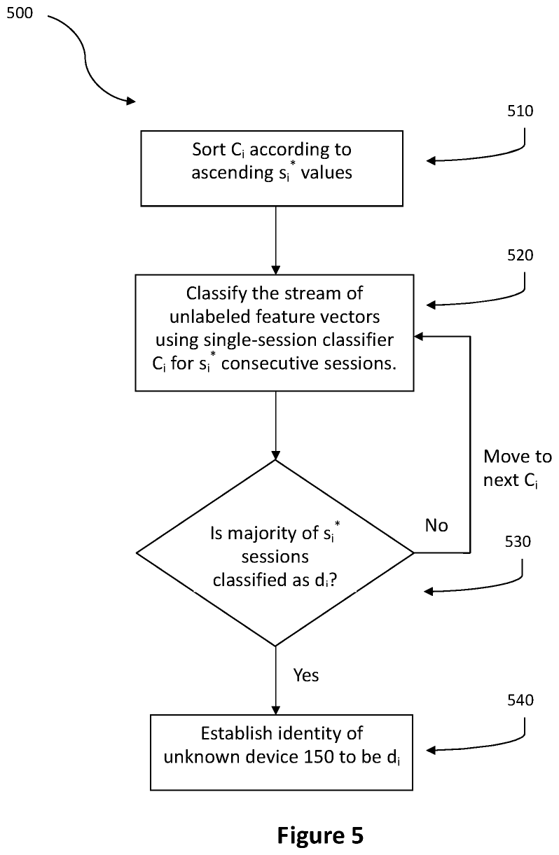

FIG. 5 is a flow diagram of the exemplary device identification process 500 of determining the identity of an unknown network-enabled device 150. The exemplary process 500 employs the device identification model described in FIG. 4. The device identification model comprises a multi-session classifier having a set of single session classifiers Cᵢ corresponding to a device dᵢ for a set of devices D, the corresponding optimal classification threshold trᵢ* and the corresponding optimal session sequence size sᵢ*.

At step 510, the set of single-session classifiers Cᵢ is sorted according to ascending sᵢ* values.

At step 520, the stream of unlabeled feature vectors is applied to a single-session classifier Cᵢ corresponding to device dᵢ with the lowest sᵢ* value. The single-session classifier Cᵢ classifies sᵢ* consecutive sessions of the unlabeled feature vectors to be originating from device dᵢ or not.

At step 530, determine whether a majority of the sᵢ* sessions were classified as device dᵢ. If the answer is yes, then at step 540, establish the identity of the unknown device 150 that originated the stream of sessions to be device dᵢ. If the answer is no, then steps 520 and 530 are repeated for the next single-session classifier with the next lowest sᵢ* value.

The device inspection order is organized by ascending sᵢ* values so that the algorithm starts to inspect devices with the lowest sᵢ* value first and follows through with increasing ᵢ* values. The search for the identity of the unknown network-enabled device 150 can be optimized in this manner.

Another way to optimize the search algorithm is to take into account the prior probability of a device being observed. In practice, this means sorting the set of classifiers by descending order of prior probabilities. For example, if a smartwatch is more probable to connect to the network than a smart refrigerator, then the classifier that determines whether the stream originated from a smartwatch would be applied before the smart refrigerators classifier.

Algorithm 2 illustrates the program for device classification.

| Algorithm 2: device classification | |
|---|---|
| 1: | procedure CLASSIFYDEVICE(C, S^{d}) |

| | |
|---|---|
| 2: | Sort C by ascending sᵢ* |
| 3: | for (Cᵢ, trᵢ*, sᵢ*) in C do |

| | |
|---|---|
| 4: | a ← 1 |
| 5: | n ← 0 |
| 6: | while a + sᵢ* − 1 <= \|S^{d}\| do |

| | |
|---|---|
| 7: | for sess in {S^{d}[a], ..., S^{d}[a + sᵢ* − 1]} do |

| | |
|---|---|
| 8: | pᵢ^{s} ← CLASSIFY(Cᵢ, sess) |
| 9: | if pᵢ^{s} ≥ trᵢ* then |

| | |
|---|---|
| 10: | n ← n + 1 |

| | |
|---|---|
| 11.: | if n > sᵢ* /2 then |

| | |
|---|---|
| 12: | return dᵢ |

| | |
|---|---|
| 13: | else |

| | |
|---|---|
| 14: | a ← a + 1 |

| | |
|---|---|
| 15: | return ’unknown’ |

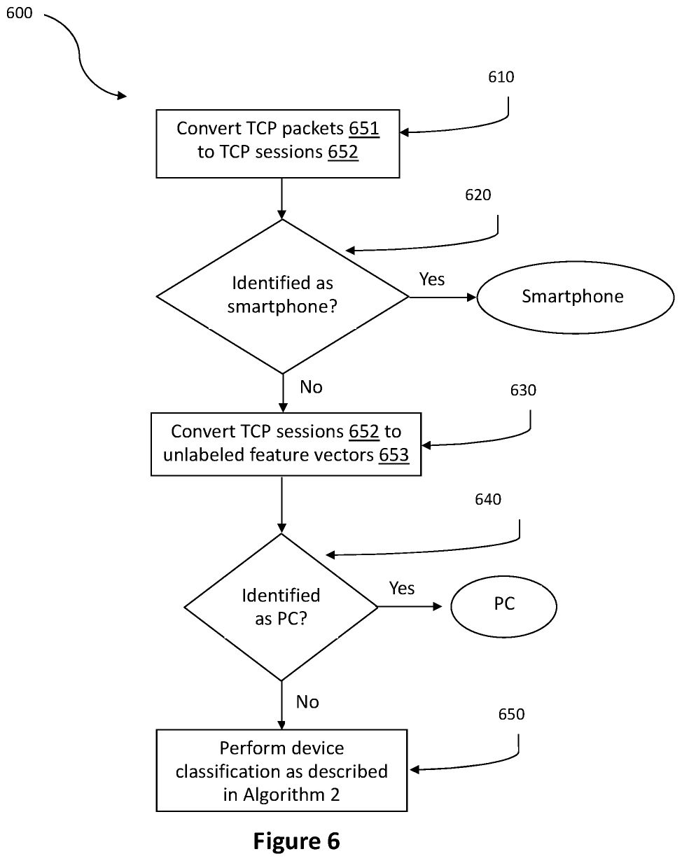

FIG. 6 is a flow diagram of an exemplary device identification process 600 for determining the identity of the unknown network enabled device 150 in the communication network 100 of FIG. 1. The exemplary process 600 begins after the computer system 120 receives network traffic, in the form of TCP packets 651, of the unknown network-enabled device 150 and a request to identify the unknown network-enabled device 150 from a list of known network-enabled devices 102. The network-enabled devices 102 comprises the IoT devices 103 and non-IoT devices 104 that have been included in the training set formed using the method described in FIG. 2.

At step 610, the TCP packets 651 originating from the unknown network-enabled device 150 are first converted to corresponding TCP sessions 652. This is achieved in the same manner as how the TCP packets 201 of the known network-enabled devices 102 are converted into TCP sessions 211 in step 210.

At step 620, classification of smartphones is performed on a TCP session by analyzing the “user agent” property string that is found in HTTP packets. The analysis has a 100% accuracy for identifying smartphones. If the unknown network-enabled device 150 is identified as a smartphone, the process 600 is completed. If the unknown network-enabled device 150 is not identified as a smartphone, then the process 600 continues to step 630.

At step 630, the TCP sessions 652 are then converted to corresponding unlabeled feature vectors 653 in the same way that the features 221 are extracted from TCP sessions 211 and formed into feature vectors 232 in step 220 and 230. However, in process 600, no third party information is added to the TCP sessions 652.

At step 640, a single session (or corresponding unlabeled feature vector) is classified using a single-session classifier. The accuracy for determining that a session originated from a PC based on a single classification of the session is found to be good. If the unknown network-enabled device 150 is identified as a PC, then the process 600 is completed. If the unknown network-enabled device 150 is not identified as a PC, then the process 600 continues to step 650.

At step 650, the device identification process 500 illustrated in FIG. 5 is performed. In particular, device classification using Algorithm 2 is performed. The identity of the unknown network-enabled device 150 is then determined from the list of known network-enabled devices 102 as described in the method 500.

The exemplary process 600 therefore determines the identity of non-IoT devices 104 (i.e. smartphones and PCs) first before using the device identification process 500 to determine the identity of the IoT devices 103. By sieving out non-IoT devices 104 such as smartphones and PCs first, the exemplary process 600 reduces the number of unknown network-enabled devices' identity to be determined. In a communication network, where the majority of network traffic may be generated by non-IoT devices 104 such as smartphones and PCs, the difference can be significant. The exemplary process 600 is therefore more efficient in determining the identity of IoT devices 103 in such a network.

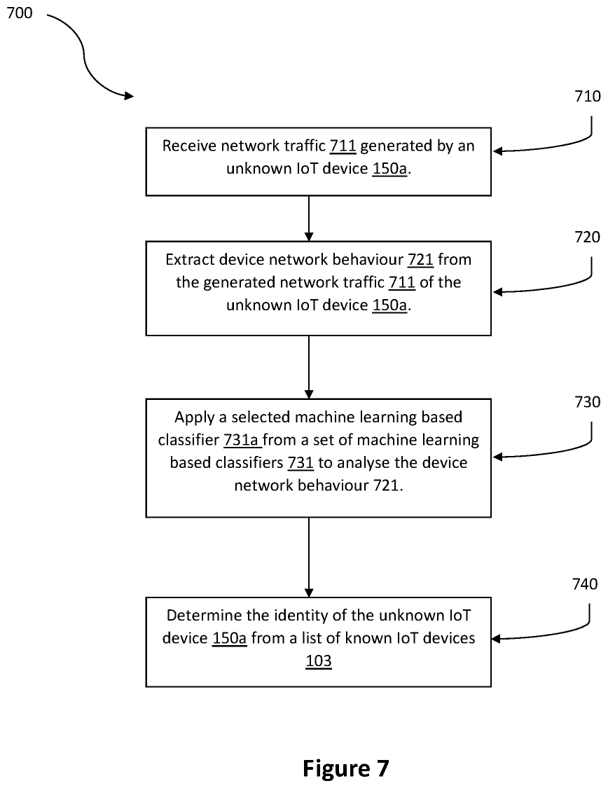

FIG. 7 is a flow diagram for illustrating an exemplary method 700 of determining an identity of an unknown IoT device in the communication network 100 of FIG. 1. The exemplary method 700 is similar to the preferred embodiment of determining an identity of an unknown device except it differs in that it is directed towards identifying an unknown IoT device 150a. The exemplary method 700 is executed by the computer system 120 described in FIG. 1. The exemplary method 700 begins when a request for the identity of an unknown IoT device 150a in the communication network 100 to be determined is issued. The request is accompanied by recorded network traffic 711 of the unknown IoT device 150a.

At step 710, the computer system 120 receives network traffic 711, in the form of TCP packets, generated by the unknown IoT device 150a.

At step 720, the device network behaviour 721 of the unknown IoT device 150a is extracted from the network traffic 711. The extraction is performed in the same manner as the extraction of features 221 from known devices 102 described in step 210 of method 200. Therefore, TCP packets originating from the network traffic 711 of the unknown IoT device 150a is first converted to corresponding TCP sessions. Features from each TCP session are extracted using the network feature extractor tool 123 of the computer system 120 and arranged in corresponding unlabeled feature vectors. Each TCP session is therefore characterized by an unlabeled feature vector comprising features extracted from the network traffic of the unknown IoT device 150a. The end product of step 720 is a set of unlabeled feature vectors representing the device network behaviour 721 of the unknown IoT device 150a.

At step 730, a selected machine learning based classifier 731a from a set of machine learning based classifiers 731 is applied to the set of unlabeled feature vectors to analyze the device network behaviour 721. The analysis is performed utilizing the device identification process described in FIG. 5 and executed by the processor 124 of the computer system 120. Each of the machine learning based classifier of the set is trained by the dataset 241 which includes the list of known IoT devices 103 shown in FIG. 1. The dataset 241 of the known IoT devices 103 is acquired and compiled utilizing methods 100 and 200 described in FIGS. 1 and 2. The dataset 241 includes a plurality of features representing network behaviour of a respective known IoT device 103 from the list and the known IoT device's identity. The set of machine learning based classifiers 731 is trained utilizing methods 300 and 400 as described in FIGS. 3 and 4. The plurality of features is then associated with the corresponding device network behaviour 721 of the generated network traffic 711.

At step 740, the identity of the unknown IoT device is determined from the list of known IoT devices 103 based on results of the analysis in step 730.

Evaluation

The device identification process 600 is evaluated for its performance characteristics using the test set DSₜₑₛₜ that was partitioned out in FIG. 3.

The performance of the device identification process 600 for classifying whether a device is IoT or non-IoT (i.e., smartphone or PC) is presented in Table 3. Using the device identification process 600, classification accuracy for smartphones is 100% while the classification of PCs is almost perfect. Therefore, the identity of unknown non-IoT devices can be determined quickly and with near perfect accuracy.

TABLE 3
PC and Smartphone classification accuracy

| | FNR | FPR | Accuracy |
|---|---|---|---|
| PC | 0.003 | 0.003 | 0.996 |
| Smartphone | 0 | 0 | 1 |

Having accurately classified the non-IoT devices (i.e., smartphones and PCs), Algorithm 2 is applied on DSₜₑₛₜ set for evaluating the performance for IoT device classification. Since Algorithm 2 is optimized to derive the type of an IoT device by analyzing a minimal number of consecutive sessions, in a worst case scenario it needs to analyze maximum (sᵢ*) consecutive sessions. In order to properly evaluate the performance of process 600, Algorithm 2 is rerun multiple times with each time omitting the first session of the sequence from the previous run. This is performed to compensate for a possible bias that may occur when the sequence begins with different sessions. Given the test set DSₜₑₛₜ in chronological order, used for evaluating the process 600, let DSⁱₜₑₛₜ be a subset of sessions in DSₜₑₛₜ originated from dᵢ, and let DSⁱₜₑₛₜ[a] be the aₜₕ session originated from dᵢ in DSⁱₜₑₛₜ. For each device dᵢ ϵ D (i.e. the set of known network-enabled devices 102), the evaluation is repeated by applying Algorithm 2 (i.e. the device identification process of FIG. 5) on all of the sub-sequences of the sessions in DSⁱₜₑₛₜ starting from session a ϵ {1, . . . , |DSⁱₜₑₛₜ|−sᵢ*+1} and ending at a+sᵢ*−1 (with maximal value a+sᵢ*−1=|DSⁱₜₑₛₜ|). Thus, for each device dᵢ ϵ D (i.e. the set of known network-enabled devices 102), the evaluation is repeated as follows:

| | |
|---|---|
| 1: | for a in {1, . . . , ([(DSₜₑₛₜⁱ)] − sᵢ* + 1)} do |

| | |
|---|---|
| 2: | s^{d} ← {DSₜₑₛₜⁱ[a], . . . , DSₜₑₛₜⁱ [a + sᵢ* − 1]} |
| 3: | CLASSIFYDEVICE (C, s^{d}) |

It is determined from Table 4 that the accuracy of Algorithm 2 in determining the identity of devices on DSₜₑₛₜ is high.

TABLE 4
Classification accuracy (Algorithm 2) on DSₜₑₛₜ

| | Number of sessions classified | | |
|---|---|---|---|
| Tested Device | Correctly | Incorrectly | ′Unknown′ |
| Printer | 14 | 0 | 0 |
| Security camera | 325 | 0 | 1 |
| Refrigerator | 2334 | 0 | 0 |
| Motion Sensor | 83 | 0 | 0 |
| Baby Monitor | 663 | 5 | 15 |
| Thermostat | 2074 | 0 | 0 |
| TV | 1566 | 12 | 18 |
| Smart watch | 151 | 2 | 0 |
| Socket | 113 | 0 | 0 |

Algorithm 1 is then executed once again, this time on DSₜₑₛₜ. The sᵢ* value previously obtained from DSₘ is compared to the sᵢ* value obtained from DSₜₑₛₜ after executing Algorithm 1. Classification accuracy measures on DSₜₑₛₜ and the recalculated sᵢ* value is shown in Table 5.

TABLE 5
Classification accuracy and recalculation of sᵢ* on DSₜₑₛₜ

| | | | | | | | s* on |
|---|---|---|---|---|---|---|---|
| | tr* | s* | Method | FNR | FPR | Acc. | DSₜₑₛₜ |
| Printer | 0.35 | 11 | GBM | 0 | 0 | 1 | 5 |
| Security Camera | 0.5 | 1 | Random | 0.004 | 0 | 0.999 | 3 |
| Refrigerator | 0.2 | 3 | XGBoost | 0 | 0.001 | 0.999 | 5 |
| Motion Sensor | 0.2 | 3 | XGBoost | 0 | 0 | 1 | 1 |
| Baby Monitor | 0.3 | 9 | XGBoost | 0.03 | 0 | 0.999 | 39 |
| Thermostat | 0.2 | 45 | Random | 0 | 0 | 1 | 39 |
| | | | Forest | | | | |
| TV | 0.1 | 23 | GBM | 0.014 | 0 | 0.997 | 45 |
| Smartwatch | 0.8 | 77 | XGBoost | 0 | 0 | 1 | 43 |
| Socket | 0.25 | 1 | Random | 0 | 0 | 1 | 1 |
| | | | Forest | | | | |

In conclusion, to obtain better results for all devices in DSₜₑₛₜ, an sᵢ* which is 4.333 times higher than the ones that are computed by Algorithm 1 on DSₘ is preferable.

Although the present disclosure has been described with reference to specific exemplary embodiments, various modifications may be made to the embodiments without departing from the scope of the invention as laid out in the claims. For example, various methods and processes described may be operated on any computer systems with the proper software tools to execute the instructions. Features may be extracted from the TCP sessions using any feature extraction tool that is readily available. Furthermore, network traffic need not be TCP packets only. Other protocols from a different layer of the network traffic may be utilized as long as it embodies network behaviour of a device. For example, HTTP, DNS and SSL protocols on the transaction level can be recorded. Consequently, features from different protocols and levels of the network traffic may be extracted for use to represent device network behaviour.

Algorithms 1 and 2 are provided for illustrating exemplary methods and steps. The exemplary methods and processes may be executed using other computing languages that are known to the skilled person and can be readily achieved by the skilled person.

Furthermore, exemplary process 700 may be expanded to include identifying other non-IoT devices such as laptops, and tablets.

Various embodiments as discussed above may be practiced with steps in a different order as disclosed in the description and illustrated in the Figures. Modifications and alternative constructions apparent to the skilled person are understood to be within the scope of the disclosure.

1. A method of determining an identity of an unknown Internet-of-Things (IoT) device in a communication network, the method comprising
receiving network traffic generated by the unknown IoT device;
extracting device network behavior from the generated network traffic; and
determining the identity of the unknown IoT device from a list of known IoT devices by applying a selected machine learning based classifier from a set of machine learning based classifiers to analyze the device network behaviour, each machine learning based classifier of the set is trained by a dataset including a plurality of features representing network behaviour of a respective known IoT device from the list and the known IoT device's identity; wherein the plurality of features being associated with the corresponding device network behaviour of the generated network traffic.

2. A method according to claim 1, wherein the network traffic includes a number of communication sessions having respective unlabeled feature vectors representing the device network behaviour of the unknown IoT device and wherein each machine learning based classifier of the set includes
a single session classifier associated with a respective known IoT device in the list and for outputting a probability;
a classification threshold for comparing with the probability to determine if the session being analyzed is generated by a particular device in the known IoT device list; and
a session sequence size defining the number of communication sessions to analyze.

3. A method according to claim 2, wherein analyzing the device network behaviour includes
(i) analyzing the unlabeled feature vector of one of the communication sessions using the single session classifier of the selected machine learning based classifier to output the probability;
(ii) comparing the probability with the classification threshold, and
(iii) if the probability is higher than the classification threshold;
(iv) classifying that the communication session is generated by a particular IoT device from the known IoT device list associated with the single session classifier; and
(v) determining the identity of the unknown IoT device from the classification.

4. A method according to claim 3, wherein if the probability is not higher than the classification threshold, selecting a next machine learning based classifier in the set and using the single session classifier of the next selected machine learning based classifier to analyze the unlabeled feature vector and repeating steps (ii) to (v).

5. A method according to claim 2, wherein analyzing the device network behaviour includes
(i) analyzing unlabeled feature vectors of consecutive communication sessions using the single session classifier of the selected machine learning based classifier to output corresponding probabilities;
(ii) comparing each of the probabilities with the respective classification thresholds;
(iii) if any of the probabilities are higher than the respective classification thresholds,
(iv) classifying those communication sessions as being generated by a particular device from the known IoT device list associated with the single session classifier; and
(v) determining the identity of the unknown IoT device based on the classification.

6. A method according to claim 5, wherein if a majority of the probabilities is not higher than the respective classification thresholds, selecting a next machine learning based classifier in the set and using the single session classifier of the next selected machine learning based classifier to analyze the unlabeled feature vectors and repeating steps (ii) to (v).

7. A method according to claim 5, further comprising selecting the machine learning based classifier from the set in sequence starting from the machine learning based classifier having the lowest session sequence size to the highest session sequence size for analyzing the unlabeled feature vectors of the consecutive communication sessions.

8. A method according to claim 1, wherein the identity of each of the known IoT devices includes the device's make and model.

9. A method of creating a training dataset for a machine learning based classifier to be used for determining an identity of an unknown device in a communication network, the method comprising
generating network traffic from a plurality of IoT devices with known identities;
extracting a plurality of features from the network traffic which are relevant to represent network behaviour of each one of the plurality of IoT devices;
associating the extracted plurality of features with the corresponding identity of each one of the plurality of IoT devices; and
creating the training dataset based on the association.

10. A method according to claim 9, further comprising converting the network traffic into communication sessions and extracting the plurality of features from each communication session.

11. A method according to claim 9, wherein the plurality of features is extracted from network, transport and application layers of the network.

12. Apparatus for determining an identity of an unknown Internet-of-Things (IoT) device in a communication network, the apparatus arranged to receive network traffic generated by the unknown IoT device, the apparatus comprising
a network feature extractor arranged to extract device network behaviour from the generated network traffic; and
a processor arranged to determine the identity of the unknown IoT device from a list of known IoT devices by applying a selected machine learning based classifier from a set of machine learning based classifiers to analyze the device network behaviour, each machine learning based classifier of the set is trained by a dataset including a plurality of features representing network behaviour of a respective known IoT device from the list and the known IoT device's identity; wherein the plurality of features being associated with the corresponding device network behaviour of the generated network traffic.

13. A communication network comprising the apparatus of claim 12, and a plurality of IoT devices.
